(19) United States
(12) Patent Application Publication
(10) Pub. No.: US 2023/0291295 A1
(43) Pub. Date: Sep. 14, 2023

(54) MAGNETOHYDRODYNAMIC PUMP FOR MOLTEN SALTS AND METHOD OF OPERATING

(71) Applicants: James L. Kirtley, Lakeworth, FL (US); David B. Eisenhaure, Cohasset, MA (US)

(72) Inventors: James L. Kirtley, Lakeworth, FL (US); David B. Eisenhaure, Cohasset, MA (US)

(21) Appl. No.: 18/005,688

(22) PCT Filed: Jul. 20, 2021
(86) PCT No.: PCT/US21/42420

§ 371 Date: Jan. 17, 2023

Related U.S. Application Data
(60) Provisional application No. 63/103,167, filed on Jul. 20, 2020.
(60) Provisional application No. 63/103,785, filed on Aug. 24, 2020.

(51) Int. Cl. H02K 44/06

(52) U.S. Cl. CPC H02K 44/06; F04B 15/04

(57) ABSTRACT

A magnetohydrodynamic pump for use in pumping molten salts that improves upon existing solutions is disclosed. The magnetohydrodynamic pump utilizes a linear induction motor with a cavity lined with ceramic and an interior piece forcing the molten salt to travel through an annular space where the magnetic. The magnetic field generated by the windings of the linear motor produce a wave of flux that will drive currents in the molten salt thus producing a force that will cause the fluid to pump. It is also an object of the disclosed concept to provide an improved method of operating a magnetohydrodynamic pump.

### RELATED APPLICATIONS

This application claims benefit of priority to U.S. Provisional Patent Application Ser. No. 63/103,167 filed on Jul. 20, 2020, and Patent Application Ser. No. 63/103,785 filed on Aug. 24, 2020 which are incorporated herein by reference.

### BACKGROUND

Power plants, such as solar thermal and nuclear power plants are moving toward utilizing molten salts. Such molten salt may be as hot as, or in excess of, 700 C and thus is difficult to handle. Due to such operating conditions, a pumping mechanism with no moving parts would be desirable.

A magnetohydrodynamic pump for pumping of molten salt is described in “Magnetohydrodynamic pumps for molten salts in cooling loops of high temperature nuclear reactors”, Ivo Dolezel et al, Przeglad Elektrotechniczny, ISSN 0033-2097, R. 87 NR May 2011. Such paper describes a DC magnetohydrodynamic system that passes current through a pipe carrying molten salt. An issue with such arrangement is that the proposed mechanism uses electrodes which are positioned in direct contact with the molten salt. Such arrangement raises issues of corrosion, erosion and other items of general concern.

An MHD pump for liquid metals, presumably also for use in liquid metal cooled reactors, is described in “Study of the Design Model of a Liquid Metal Induction Pump’, C. A. Borghi et al. IEEE Transactions on Magnetics, V. 34, No. 5, September, 1998. Such paper describes an induction machine based pumping system.

### SUMMARY OF THE INVENTION

Accordingly, it is an object of the disclosed concept to provide a magnetohydrodynamic pump for use in pumping molten salts that improves upon existing solutions. It is also an object of the disclosed concept to provide an improved method of operating a magnetohydrodynamic pump.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1 is a schematic representation of sectional views of a pump mechanism in accordance with an example embodiment of the disclosed concept;

FIG. 2 is a schematic sectional view of an inner magnetic circuit in accordance with an example embodiment of the disclosed concept;

FIG. 3 is a detailed schematic sectional view showing details of the winding arrangement in the motor portion a pump mechanism in accordance with an example embodiment of the disclosed concept;

FIG. 4 is a schematic view showing the general layout of lamination bundles in a back-iron portion of a pump mechanism in accordance with an example embodiment of the disclosed concept;

FIG. 5 shows winding laminations disposed in a bent, involute form in accordance with example embodiment of the disclosed concept; and

FIG. 6 shows a schematic arrangement of an example power supply in accordance with an example embodiment of the disclosed concept.

### DETAILED DESCRIPTION OF EXEMPLARY EMBODIMENTS

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs.

As used herein, “directly coupled” means that two elements are directly in contact with each other.

As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body.

As employed herein, the statement that two or more parts or components “engage” one another shall mean that the parts exert a force against one another either directly or through one or more intermediate parts or components.

As employed herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The present invention will now be described, for purposes of explanation, in connection with numerous specific details in order to provide a thorough understanding of the subject invention. It will be evident, however, that the present invention can be practiced without these specific details without departing from the spirit and scope of this innovation.

From the following description it is to be readily appreciated that embodiments of the disclosed concept provide a number of improvements over existing solutions. Such improvements include, without limitation:
Ways of protecting the windings from the high temperature molten salt,
Establishing reasonably high pressure in the working fluid, and
Practical ways of making the magnetic circuits of the stator and the return path for magnetic flux.

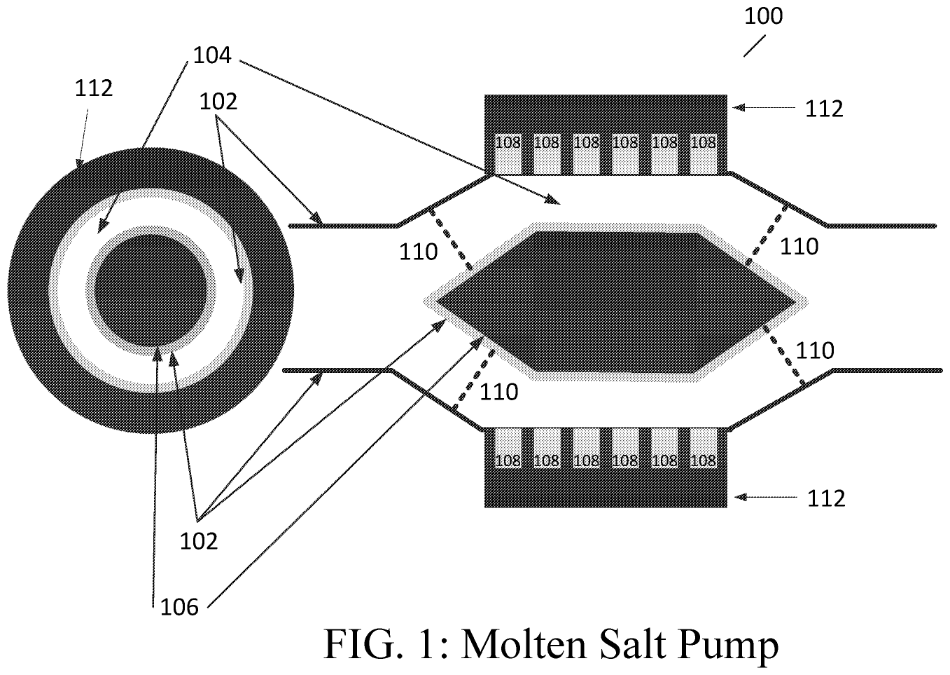

FIG. 1 is a schematic representation of sectional views of a pump mechanism 100 in accordance with an example embodiment of the disclosed concept. In this device, a polyphase, cylindrical, linear induction motor, consisting of circular coils 108 mounted in slots in a magnetic circuit 112, supports a traveling wave of magnetic induction that pushes the molten salt using currents induced in the molten salt by magnetic flux from the coils. The magnetic flux returns through a ferromagnetic circuit inside an inner capsule 106 supported by short vanes in the fluid path. The inner capsule, consisting of the ceramic inner wall 102 and the steel return path, is supported by a set of supporting vanes 110. The inner capsule and the magnetic circuit 112 form the back iron of the motor. Preferably, such supporting vanes are located toward the inlet and outlet to the motor, positioned so as to minimize interrupting the circulating current in the working fluid.

The fluid path 104 is a relatively narrow annular region between the stator and the inner capsule. Such arrangement permits the pump to produce a high pressure. By using a circular channel, edge effects and end turns of the windings are avoided and maximum use is made of the winding conductors.

The fluid flow path is defined by a non-electrically conducting, non-magnetic pipe, made, for example without limitation, from a ceramic material that separates the high temperature working fluid (e.g., molten salt heated to approximately 700° C.) from the windings and outer magnetic circuit; and a separate “capsule” made of the same or similar non-conducting material that surrounds a magnetic circuit inside positioned inside the fluid flow region. It is important that the structure have no or very limited conductivity in the azimuthal direction.

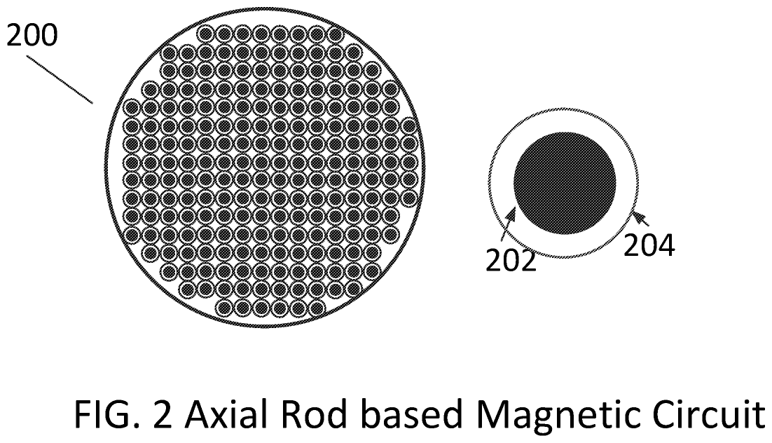

In this concept, the inner magnetic circuit is made of longitudinally arranged rods in a fashion that looks, on axial view, roughly like the arrangement as shown in FIG. 2. The magnetic circuit element 200 is made of rods 202, or wires, axially disposed, with electrical insulation 204 around them to interrupt any azimuthal currents that might flow in the absence of insulation. The rods are made of a magnetic material with a Curie temperature sufficiently higher than the working temperature of the pump arrangement to ensure that the rods provide an adequate magnetic return path. The annular spacing between the inner magnetic circuit in the capsule and the outer magnetic circuit is relatively thin, so that generation of magnetic flux density by currents in the stator can be effective.

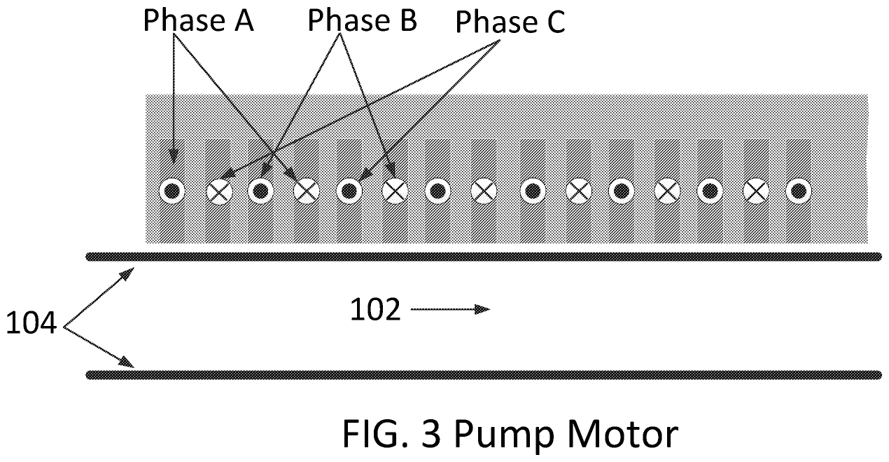

The motor portion of the pump is cylindrical, with circular coils arranged in a conventional linear electric motor configuration such as shown in FIG. 3. The example shown in FIG. 3 shows a single slot per pole per phase configuration, so that each phase coil repeats in each sixth slot. Shown is a three-phase configuration with Phase A, Phase B, and Phase C. However, it is to be appreciated that this winding could also be modified to have more than one slot per pole per phase, and even to have ‘short pitch’ windings in the commonly understood fashion. When driven by a voltage or current source that is ‘balanced’ in the conventionally understood sense, this winding will produce a traveling wave of flux that will drive currents in the molten salt working fluid that will interact with the flux produced by the currents in the stator to produce a force in the salt. Such force provides for pumping of the fluid in the direction of flow. By having a radially thin annulus, the magnetic flux density can be high, providing for current densities and force densities that can move the molten salt, despite its relatively low electrical conductivity.

To keep the temperature of the windings of the motor portion of the pump within acceptable bounds, a cooling mechanism, e.g., without limitation a water or oil carrying jacket, is provided around the outside of the motor and/or between the motor windings and the ceramic sleeve. A cooling arrangement may also be provided to the “capsule” portion of the pump arrangement. For instance, there may be channels within the ceramic material or adjacent to the ceramic material to conduct cooling fluid.

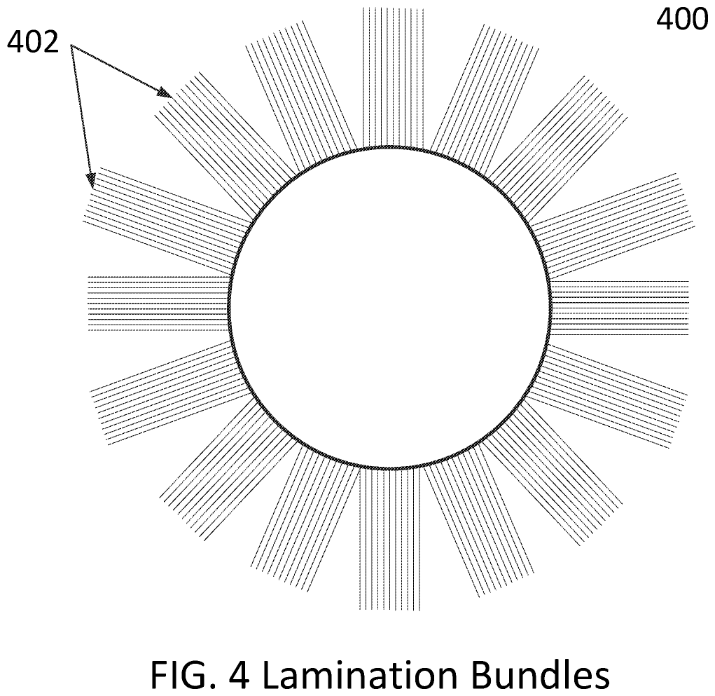

Circular cylindrical windings and associated magnetic circuits are problematic, in that the magnetic circuit laminations do not always lay in convenient directions. In such a machine, the laminations should be arrayed in such a way as to have very low azimuthal conductivity. Such a stator could be arranged in a fashion as shown in FIG. 4. In such arrangement, the laminations are arranged in bundles 402 that pack tightly together at the outer radius of the ceramic cylinder that makes up the containment for the working fluid 400. Each bundle 402 is repeated until the outer ring of bundles encircle the containment forming at least in part the back-iron element 112. At the outer radius of the motor there are gaps between the laminations.

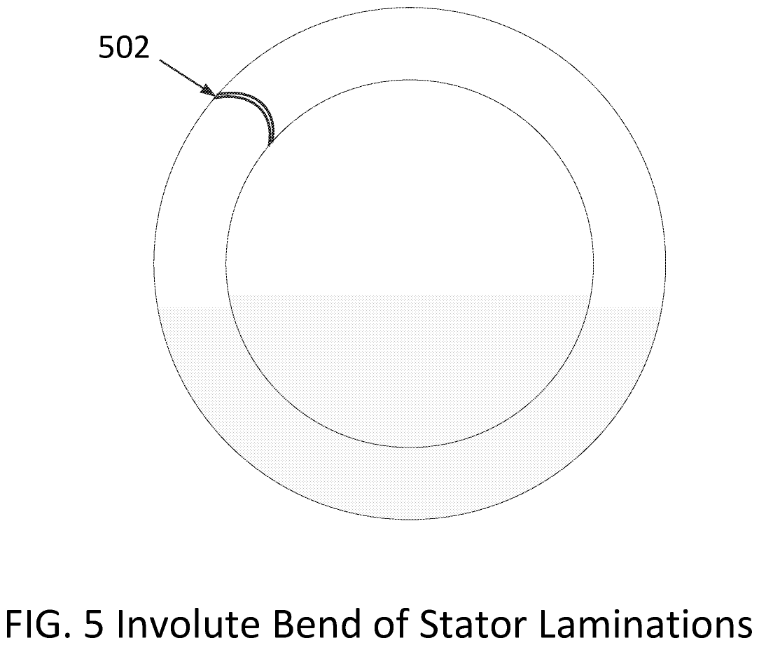

A more compact design can be made by bending each of the laminations into an involute form, such that each lamination is radial in disposition at the inner radius (corresponding to the outer radius of the ceramic sleeve), but bent at an angle so that the laminations fit tightly together over the radial extent of the stator. Such arrangement results in a smaller radial build. FIG. 5 shows, schematically with an involute shape 502.

An alternative method for building a pumping mechanism for pumping molten salts would be to substitute the cylindrical motor with a more conventional motor stator and an axially laminated capsule. The conventional motor stator would be very similar to the stator of an induction or brushless DC motor, comprising axial currents and radial magnetic flux density. The capsule would contain an axially laminated magnetic circuit. The motor would provide azimuthal force on the molten salt working fluid, causing it to ‘swirl’. Then, stator fins in the gap between the stator and capsule would convert the swirl to axial force on the working fluid.

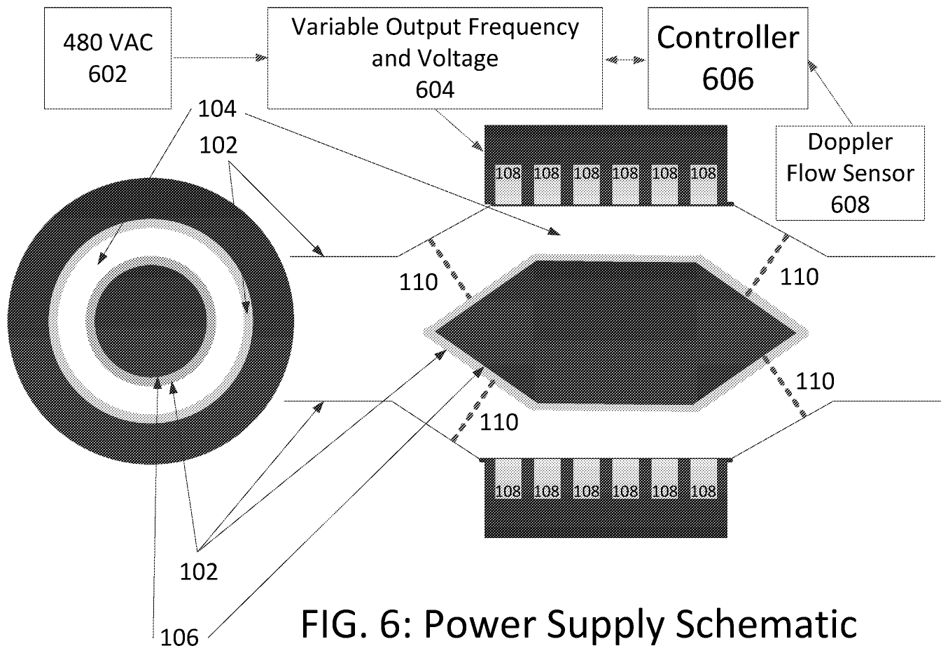

In an example embodiment of the disclosed concept, such as shown in the schematic diagram of FIG. 6, power is supplied from a 480 VAC 60 Hz source 602 which is electrically coupled to a polyphase converter 604 delivering the necessary signals to each phase of the magnetic circuit. The polyphase converter is capable of delivering a variable voltage and variable frequency output. A controller 606 monitors the actual voltage and frequency of the AC input and provides a commanded output voltage and frequency depending on current flow conditions (e.g., such as detected by a Doppler flow sensor 608). As the system, has relatively little damping, a feed control arrangement may be employed to prevent flow oscillation. A control law may be employed which accounts for characteristics of the particular pump characteristics, however, generally output voltage and frequency are proportional to the required flow.

It is to be appreciated that pump arrangements as described herein may be employed in other applications in addition to solar thermal and molten salt reactors. Other applications include, for example, without limitation: acids, industrial waste, slurries, salt mixtures, molten metals, and many others.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

### Combination of Features

Features described above as well as those claimed below may be combined in various ways without departing from the scope hereof. The following examples illustrate possible, non-limiting combinations of features and embodiments described above. It should be clear that other changes and modifications may be made to the present embodiments without departing from the spirit and scope of this invention:

(A1) In an embodiment of a first aspect a magnetohydrodynamic pump. comprising a polyphase linear induction motor stator with circular coils mounted in slots around a magnetic structure; an inner cavity having ceramic walls and a center structure that forces working fluid into an annular space as the working fluid travels through the magnetohydrodynamic pump.

(A2) In the embodiment (A1) wherein the working fluid is a molten salt.

(A3) in the embodiment (A1)-(A2) wherein the polyphase linear induction motor stator is three phase.

(A4) in the embodiment (A1)-(A3) further comprising a cooling jacket surrounding the linear induction motor stator, to carry coolant therethrough

(A5) in the embodiment (A1)-(A4) wherein the center structure is supported by veins.

(A6) in the embodiment (A1)-(A5) wherein the center structure forms a ferromagnetic circuit.

(A7) in the embodiment (A1)-(A6) wherein the center structure is coated with a ceramic material.

(A8) in the embodiment (A1)-(A7) wherein the linear motor stator comprises magnetic material including laminations.

(A9) in the embodiment (A8) wherein the laminations being in a plurality of bundles.

(A10) in the embodiment (A8)-(A9) wherein the plurality of bundles encircle the magnetohydrodynamic pump and contain the working fluid

(A11) in the embodiment (A8)-(A10) wherein the laminations being in an involute shape such that each of the laminations is radial at the inner radius

What is claimed is:

1. A magnetohydrodynamic pump for molten salts comprising:
a polyphase linear induction motor stator with circular coils mounted in slots around a magnetic structure; an inner cavity having ceramic walls and a center structure that forces working fluid into an annular space as the working fluid travels through the magnetohydrodynamic pump.

2. The magnetohydrodynamic pump of claim 1, wherein the working fluid is a molten salt.

3. The magnetohydrodynamic pump of claim 1, wherein the polyphase linear induction motor stator is three phase.

4. The magnetohydrodynamic pump of claim 1, further comprising a cooling jacket surrounding the linear induction motor stator, to carry coolant therethrough.

5. The magnetohydrodynamic pump of claim 1, wherein the center structure is supported by veins.

6. The magnetohydrodynamic pump of claim 1, wherein the center structure forms a ferromagnetic circuit.

7. The magnetohydrodynamic pump of claim 1, wherein the center structure is coated with a ceramic material.

8. The magnetohydrodynamic pump of claim 1, wherein the linear motor stator comprises magnetic material including laminations.

9. The laminations of claim 8, the laminations being in a plurality of bundles.

10. The lamination bundles of claim 9, wherein the plurality of bundles encircle the magnetohydrodynamic pump and contain the working fluid.

11. The lamination bundles of claim 10, the laminations being in an involute shape such that each of the laminations is radial at the inner radius.
